(19) United States
(12) Patent Application Publication
(10) Pub. No.: US 2026/0039478 A1
(43) Pub. Date: Feb. 5, 2026

(54) CRYPTO KEY CUTTING SYSTEM

(71) Applicant: Neevai Abraham ESINLI, Holon (IL)

(72) Inventor: Neevai Abraham ESINLI, Holon (IL)

(21) Appl. No.: 18/788,267

(22) Filed: Jul. 30, 2024

(51) Int. Cl. H04L 9/32

(52) U.S. Cl. CPC H04L 9/3247; H04L 9/3226

(57) ABSTRACT

There is provided a device for signing and/or encrypting data using a physical key, comprising: a first interface configured for receiving digital data, a second interface configured for receiving an encoded physical key with a cut and/or engraved geometrical representation representing a private cryptographic key, the second interface implemented as a lock cylinder configured for insertion of the encoded physical key therein, a reading component configured for reading the geometrical representation from the encoded physical key for obtaining the private cryptographic key, in response to a rotation of the lock cylinder with encoded physical key inserted therein, circuitry configured for: signing and/or encrypting the digital data using the private cryptographic key obtained by reading the encoded physical key, wherein the circuitry computes the signature and/or encryption of the digital data without storing the private cryptographic key and/or without storing a digital representation of the private cryptographic key on a memory.

### FIELD AND BACKGROUND OF THE INVENTION

The present invention, in some embodiments thereof, relates to cybersecurity and, more particularly, but not exclusively, to methods and systems for cryptography based signing and/or encrypting of data.

Messages sent over an insecure channel, such as a publicly accessible network, require a mechanism to enable the receiver to trust that the originator actually sent the message. Cryptographic methods are used to digitally sign the message.

Digital signing of messages is used, for example, in blockchain environments, to verify the authenticity of a transaction, for example, transfer of cryptocurrencies from one digital wallet to another digital wallet.

Cryptographic methods may be used to encrypt the messages, such as for transmission over the insecure channel. Encryption is designed to prevent non-desired entities from reading the contents of the messages. Only trusted entities are granted the ability to decrypt the encrypted contents of the message.

### SUMMARY OF THE INVENTION

According to a first aspect, a device for signing and/or encrypting digital data using an encoded physical key, comprises: a first interface configured for receiving digital data, a second interface configured for receiving an encoded physical key with a cut and/or engraved geometrical representation representing a private cryptographic key, the second interface implemented as a lock cylinder configured for insertion of the encoded physical key therein, a reading component configured for reading the geometrical representation from the encoded physical key for obtaining the private cryptographic key, in response to a rotation of the lock cylinder with encoded physical key inserted therein, circuitry configured for: signing and/or encrypting the digital data using the private cryptographic key obtained by reading the encoded physical key, wherein the circuitry computes the signature and/or encryption of the digital data without storing the private cryptographic key and/or without storing a digital representation of the private cryptographic key on a memory.

In a further implementation form of the first aspect, the lock cylinder is configured as a universal interface for rotation and reading the geometrical representation on a plurality of different encoded physical keys with different geometrical representations.

In a further implementation form of the first aspect, the lock cylinder is configured as a specific interface for rotation and reading a unique geometrical representation on a specific encoded physical key with unique geometrical representation, wherein the lock cylinder is configured for non-rotation and non-reading a geometrical representation different than the unique geometrical representation.

In a further implementation form of the first aspect, the lock cylinder is configured as a specific interface for rotation and reading a defined set of a plurality of geometrical representations on a set of a plurality of encoded physical keys generated based on a multi-party computation (MPC) protocol for encryption and/or signing, wherein the lock cylinder is configured for non-rotation and non-reading a geometrical representation different than the defined set of the plurality of geometrical representations.

In a further implementation form of the first aspect, further comprising the memory configured for storing the digital data and the signature and/or encryption of the digital data.

In a further implementation form of the first aspect, further comprising a data interface configured for interfacing with at least one of a network and an external computing environment for sending and/or receiving digital data, and the circuitry is further configured for disabling the data interface during the signing and/or the encryption.

In a further implementation form of the first aspect, further comprising a data interface configured for interfacing with at least one of a network and an external computing environment, and the circuitry is further configured for sending the signed digital data and/or the encrypted digital data over the data interface after the signing and/or encrypting is complete.

In a further implementation form of the first aspect, further comprising a data interface configured for interfacing with at least one of a network and an external computing environment for sending the signed digital data and/or the encrypted digital data, and the circuitry is further configured for non-simultaneous operation of the data interface and the second interface, wherein the second interface is disabled when the data interface is operable for sending and/or receiving of data, and the data interface is disabled when the second interface is reading the geometrical representation.

In a further implementation form of the first aspect, further comprising a third interface for receiving a PIN entered by a user, wherein the reading component is further configured for reading a PIN from the encoded physical key, and the circuitry is further configured for performing the signings and/or encrypting in response to a match of the PIN obtained from the third interface with the PIN obtained from the encoded physical key, and not performing the signings and/or encrypting in response to a mismatch of the PIN obtained from the third interface with the PIN obtained from the encoded physical key.

In a further implementation form of the first aspect, further comprising: a data interface configured for interfacing with at least one of a network and an extra computing environment and for sending of the signed digital and/or the encrypted digital data, and wherein the circuitry is configured for operating the data interface in response to removal of the encoded physical key from the lock cylinder.

In a further implementation form of the first aspect, further comprising a data interface configured for interfacing with at least one of a network and an external computing environment for sending the signed digital data and/or the encrypted digital data, and the circuitry is further configured for disabling the data interface in response to the reading component detecting presence of the encoded physical key in the lock cylinder, and for enabling the data interface in response to the reading component detecting lack of presence of the encoded physical key in the lock cylinder.

In a further implementation form of the first aspect, the cut and/or engraved geometrical representation represents a seed phrase defined by a cryptographic process, and further comprising circuitry for converting the seed phrase to the private cryptographic key.

In a further implementation form of the first aspect, the reading component is implemented as a plurality of pins positioned within the lock cylinder, the plurality of pins set for displacement in response to the geometrical representation by the encoded physical key located within the lock cylinder, wherein the geometrical representation is read according to the displacement of the plurality of pins.

According to a second aspect, a device for physically generating an encoded physical key from a blank physical key, comprises: a first interface configured for receiving a cryptographic token defined by a cryptographic process, a second interface configured for receiving the blank physical key, and further comprising circuitry configured for: mapping the cryptographic token to a geometrical representation, and operating a component for cutting and/or engraving the geometrical representation on the blank physical key for generating an encoded physical key comprising the geometrical representation of the cryptographic token on the blank physical key.

In a further implementation form of the second aspect, the geometrical representation is cut and/or engraved for fitting within a lock cylinder for enabling rotation of the lock cylinder when the encoded physical key is located within the lock cylinder.

In a further implementation form of the second aspect, the geometrical representation is cut and/or engraved for displacement of a plurality of pins of the lock cylinder, wherein the geometrical representation is read according to the displacement of the plurality of pins by the encoded physical key located within the lock cylinder.

In a further implementation form of the second aspect, further comprising circuitry configured for operating a second component for generating the lock cylinder corresponding to the geometrical representation of the encoded physical key, wherein the lock cylinder is generated for rotation and reading the corresponding geometrical representation of the encoded physical key and configured for non-rotation and non-reading a second geometrical representation different than the geometrical representation of the encoded physical key.

In a further implementation form of the second aspect, the circuitry is further configured for operating the component for cutting and/or engraving a plurality of geometrical representations on a plurality of blank physical keys based on a multi-party computation (MPC) protocol for encryption and/or signing.

In a further implementation form of the second aspect, the cryptographic token comprises a private cryptographic key defined by the cryptographic process.

In a further implementation form of the second aspect, the cryptographic token comprises a seed phrase defined by the cryptographic process, and at least one of wherein the seed phrase is mapped to the geometrical representation, and wherein the circuitry is further configured for computing a private cryptographic key from the seed phrase, wherein the private cryptographic key is mapped to the geometrical representation.

In a further implementation form of the second aspect, the blank physical key is designed for cutting for fitting into a lock cylinder.

In a further implementation form of the second aspect, the component cuts and/or engraves the blank physical key for being read by a universal reader that decodes a plurality of different geometrical representations of a plurality of different keys

In a further implementation form of the second aspect, the first interface comprises a touchscreen and/or screen and keyboard for manual entry of the cryptographic token.

In a further implementation form of the second aspect, the device excludes a data interface for connection to a network and/or external computing environment.

In a further implementation form of the second aspect, the first interface is further configured for receiving a PIN number, the circuitry is further configured for mapping the PIN number to a second geometrical representation, and the component is further operated for cutting and/or engraving the second geometrical representation on the blank physical key.

In a further implementation form of the second aspect, the geometrical representation includes a plurality of parameters corresponding to a plurality of characters of the cryptographic token, the plurality of parameters include at least one of: number of teeth, angle of teeth, height of teeth, pattern of teeth, holes in a blade, shape of holes, depth of holes, diameter of holes, distribution pattern of holes.

In a further implementation form of the second aspect, further comprising a random generator configured for generating random cryptographic tokens, wherein the first interface accesses the random generator for obtaining a random cryptographic token as the cryptographic token, wherein the random cryptographic token is not stored on local memory during and/or after the mapping to the geometrical representation.

According to a third aspect, an encoded physical key comprises: a blank physical key including a cut and/or engraved geometrical representation of a cryptographic token defined by a cryptographic process.

In a further implementation form of the third aspect, the blank physical key is designed for cutting for fitting into a lock cylinder.

In a further implementation form of the third aspect, the encoded physical key is designed for being read by a universal reader that decodes a plurality of different geometrical representations of a plurality of different encoded physical keys.

In a further implementation form of the third aspect, the geometrical representation includes a plurality of parameters corresponding to a plurality of characters of the cryptographic token, the plurality of parameters include at least one of: number of teeth, angle of teeth, height of teeth, pattern of teeth, holes in a blade, depth of holes, diameter of holes, distribution pattern of holes.

In a further implementation form of the third aspect, further including a cut and/or engraved second geometrical representation of a PIN.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of a system for signing and/or encrypting data using an encoded physical key, in accordance with some embodiments of the present invention;

FIG. 2 is a block diagram of an encoder for generating an encoded physical key, in accordance with some embodiments of the present invention;

FIG. 3 is a schematic of an encoded physical key, in accordance with some embodiments of the present invention;

FIG. 4 is a block diagram of a decoder for signing and/or encrypting data using an encoded physical key, in accordance with some embodiments of the present invention;

FIG. 5 is a flowchart of an exemplary method of generating an encoded physical key, and using the encoded physical key for signing and/or encrypting data, in accordance with some embodiments of the present invention; and

FIG. 6 is a schematic of another encoded physical key, in accordance with some embodiments of the present invention.

### DESCRIPTION OF SPECIFIC EMBODIMENTS OF THE INVENTION

The present invention, in some embodiments thereof, relates to cybersecurity and, more particularly, but not exclusively, to methods and systems for cryptography based signing and/or encrypting of data.

As used herein, the term private cryptographic key, cryptographic token, private key, and seed phrase, may sometimes be used interchangeably. The geometric representation of the encoded physical key may be a physical representation of the private cryptographic key, cryptographic token, private key, and/or seed phrase.

An aspect of some embodiments of the present invention relates to system that includes one or more of: a device for physically generating an encoded physical key(s) from a blank physical key(s) (also referred to herein an encoder), the encoded physical key(s), and a device for signing and/or encrypting digital data using the encoded physical key(s) (also referred to herein as decoder).

The encoder includes a first interface designed for receiving a cryptographic token defined by a cryptographic process, for example, a touch screen, and/or a keypad. The cryptographic token may be, for example, a seed phrase and/or a private key (also referred to herein as a private cryptographic key). The encoder further includes a second interface sized and/or shaped and/or designed for receiving the blank physical key, which is in associated with operating a component for cutting and/or engraving the blank physical key. The encoder further includes circuitry designed and/or executing code for mapping the cryptographic token to a geometrical representation, for example, each character of the cryptographic token is mapped to a tooth having a parameters(s) (e.g., a certain angle, height, length) and/or a parameter(s) of a hole drilled into the blank (e.g., diameter, depth, pattern of distribution, location). The circuitry operates the component for cutting and/or engraving the geometrical representation on the blank physical key for generating the encoded physical key including a physical representation of the cryptographic token on the blank physical key.

The encoded physical key includes a blank physical key with a cut and/or engraved geometrical representation of a cryptographic token defined by a cryptographic process, for example, teeth having parameter(s) and/or holes having parameter(s), as described herein.

The decoder includes a first interface configured for receiving digital data for signing and/or encrypting, for example, a network interface, a touch screen, and a short range interface (e.g., wireless, wired) which may connected to a mobile device. The decoder further includes a second interface sized and/or shaped and/or designed for receiving an encoded physical key with a cut and/or engraved geometrical representation representing a private cryptographic key, optionally a lock cylinder sized and/or shaped and/or designed for insertion of the encoded physical key therein. The decoder further includes a reading component designed for reading the geometrical representation from the encoded physical key for obtaining the private cryptographic key, optionally in response to a rotation of the lock cylinder with encoded physical key inserted therein. The reading component may be implemented as, for example, multiple pins set to be displaced by the geometrical representation of the encoded physical key located within the lock cylinder. The decoder further includes circuitry designed and/or executing a code for signing and/or encrypting the digital data using the private cryptographic key obtained by reading the encoded physical key. The circuitry is designed for computing the signature and/or encryption of the digital data without storing the private cryptographic key and/or without storing the digital representation on a memory. The circuitry may be designed for disabling a data interface during the signing and/or encryption, for preventing external access to computation.

At least some embodiments described herein address the technical problem of improving security of a private key and/or seed phrase used for cryptography, such as signing of digital data (e.g., for performing transfer of cryptocurrency such as via a blockchain) and/or for encrypting data. At least some embodiments described herein improve the technology of cybersecurity and/or cryptography, by improving security of a private key and/or seed phrase, such as used for signing of digital data and/or for encrypting data. At least some embodiments described herein improve over prior approaches of securing a private key and/or seed phrase.

Existing approaches include storing a digital representation of the private key on a computing cloud, which may be managed by an external third party, or a private user may be granted storage space for managing their own storage which is hosted by the external third party. Such approaches of storing digital keys are dependent on the security of the third party, and therefore may be prone to cyberattack. Other existing approaches include printing the private key on a piece of paper or other physical medium, and storing the paper. Such approach is prone to the paper being lost, and/or its location being forgotten. Yet other approaches are based on a hardware security module (HSM), which is a dedicated hardware device that provides secure management of digital keys and cryptographic operations. HSMs use digital keys, which may be stolen via a cybersecurity attack. Moreover, HSM require complex hardware.

At least some embodiments described herein address the aforementioned technical problem(s) and/or improve upon the aforementioned technical field(s) and/or improve upon the aforementioned prior approaches, by providing an encoder that generates an encoded physical key, the encoded physical key, and/or a decoder that reads the encoded physical key. The encoded physical key may be a representation of a private key and/or seed phrase (also referred to herein as a private cryptographic key), which may be used for signing and/or encrypting of digital data, without storing a digital representation of the private cryptographic key on a memory. The digital representation of the private cryptographic key cannot be accessed at any time, since it is physically represented by the encoded physical key and is not available in accessible digital format at any point, not stored on a memory and/or external access (e.g., via an interface) may be disabled during the computations. The encoded physical key may appear similar to a standard door key and/or to a standard key of a lock, reducing risk of theft and/or enabling storage of the encoded physical key together with standard door and/or lock keys. The encoded physical key may enhanced a user experience of performing digital signing of data and/or encryption of data, by simplifying the process—the user simply inserts the encoded physical key into the lock cylinder and turns the encoded physical key for securely signing and/or encrypting data. Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

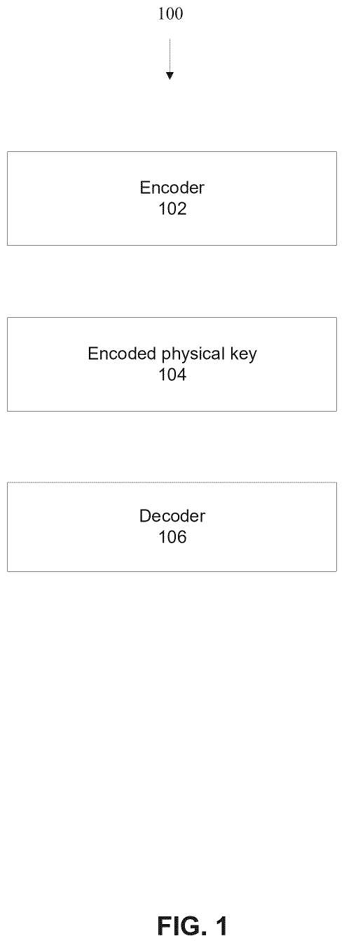

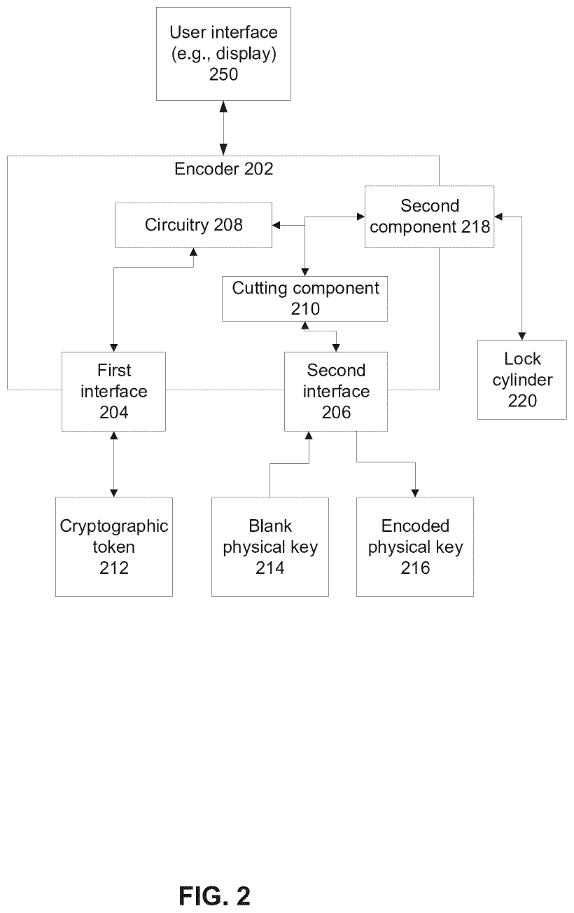

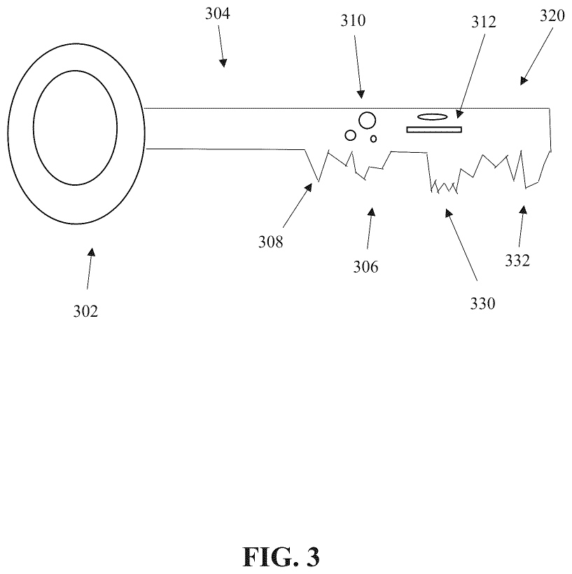

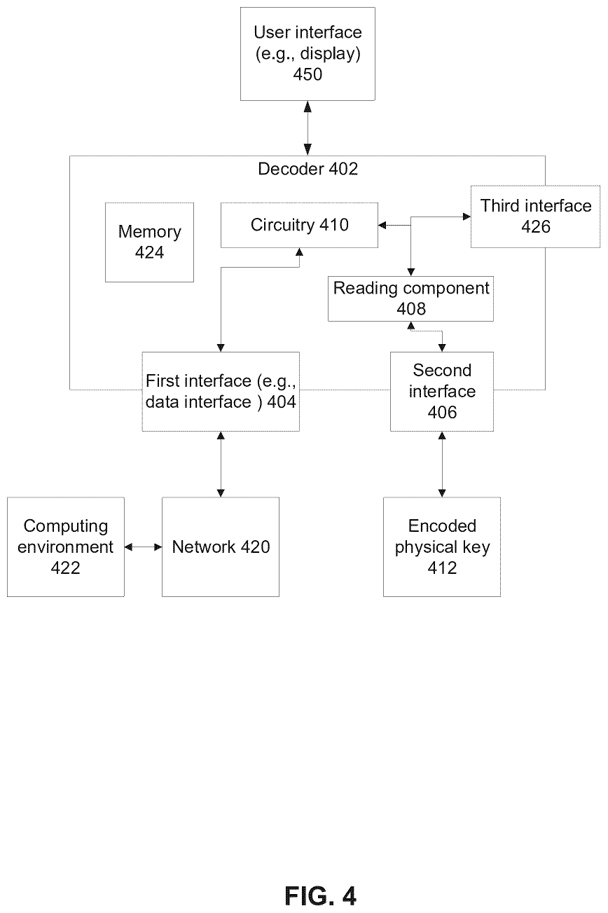

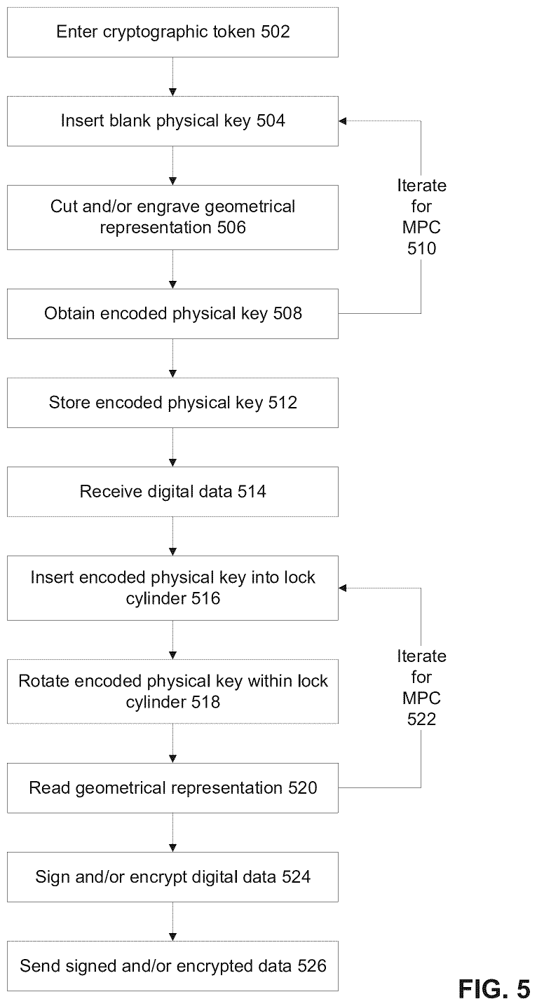

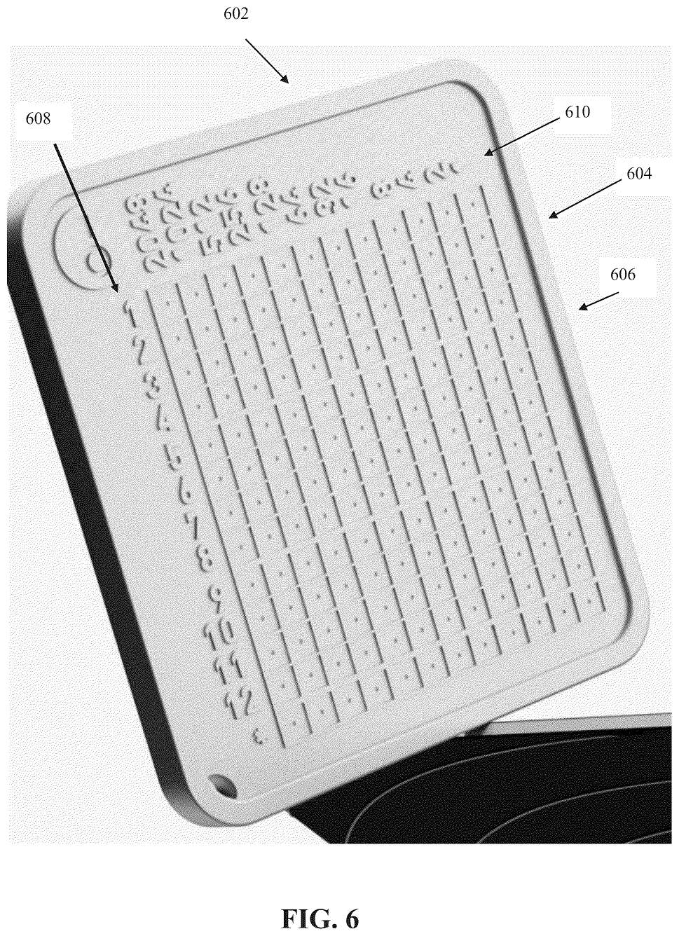

Reference is now made to FIG. 1, which is a block diagram of a system 100 for signing and/or encrypting data using an encoded physical key, in accordance with some embodiments of the present invention. Reference is also made to FIG. 2, which is a block diagram of an encoder 202 for generating an encoded physical key, in accordance with some embodiments of the present invention. Reference is also made to FIG. 3, which is a schematic of an encoded physical key 302, in accordance with some embodiments of the present invention. Reference is also made to FIG. 4, which is a block diagram of a decoder 402 for signing and/or encrypting data using an encoded physical key, in accordance with some embodiments of the present invention. Reference is also made to FIG. 5, which is a flowchart of an exemplary method of generating an encoded physical key, and using the encoded physical key for signing and/or encrypting data, in accordance with some embodiments of the present invention. Reference is also made to FIG. 6, which is a schematic of another encoded physical key 602, in accordance with some embodiments of the present invention

Referring now back to FIG. 1, system 100 includes one or more of the following components:
An encoder 102 (i.e., device) for generating an encoded physical key 104, for example, as described with reference to encoder 202 of FIG. 2.
Encoded physical key 104, for example, as described with reference to encoded physical key 302 of FIG. 3 and/or encoded physical key 602 of FIG. 6.
A decoder 106 (i.e., device) for signing and/or encrypting data using encoded physical key 104, for example, as described with reference to decoder 402 of FIG. 4.

Components of system 100 may be operated, for example, as described with reference to FIG. 5.

Referring now back to FIG. 2, encoder 202 includes a first interface 204, a second interface 206, circuitry 208, and a component for cutting and/or engraving (also referred to herein as cutting component) 210.

Encoder 202 may excludes a data interface for connection to a network and/or external computing device. The exclusion of the data interface prevents cyberattacks from external sources, remotely over the network and/or directly via the external computing device. A cryptographic token 212 used to generate the geometrical representation of the encoded physical key remains within encoder 202, and cannot be obtained by a network connected device and/or external computing device.

First interface 204 is designed for receiving a cryptographic token 212, for example, a seed phrase, a private cryptographic key, and the like. Cryptographic token 212 may be defined by a cryptographic process, for example, a standard defining the seed phrase and/or private cryptographic key. When the cryptographic token 212 is a seed phrase, circuitry 208 may be designed for computing a private key according to the seed phrase following a defined protocol. In another example, circuitry 208 may be designed for computing Hierarchical Deterministic (HD) wallets such as BIP 32/39/44 compatible, from 12-24 words as the seed, and converting the seed into a number for being cut and/or engraved as the geometrical representation.

Optionally, the cryptographic token is not stored on local memory during and/or after the mapping to the geometrical representation on the encoded physical key.

First interface 204 may be designed for direct entry of cryptographic token 212 by a user, such as manually. First interface 204 may be implemented as, for example, a touchscreen and/or screen and keyboard for manual entry of the cryptographic token. In other embodiments, first interface 204 may include speakers and/or a microphone, for speech directed input and/or for playing audio messages.

Encoder may include and/or be in communication with a user interface 250 for presentation of data to a user, for example, a screen and/or lights and/or message display. User interface 250 may present, for example, instructions to the user on what to do (e.g., place blank 214 in second interface 206, remove encoded key 216) and/or present an indication of a current state of encoder 202 (e.g., computing, cutting key, key ready). User interface 250 may be combined and/or integrated with first interface 204, for example, as a touch screen for a user to enter data and for presentation of instruction and/or the current state.

First interface 204 may be designed for receiving a PIN number, or other identifier, for example, of a user. The PIN may serve as a second layer of security, for example, the user first enters their PIN number to identify themselves, and then enters the cryptographic token 212.

First interface 204 may include and/or be in communication with a random generator designed for generating random cryptographic tokens. First interface 204 may access the random generator for obtaining a random cryptographic token as the cryptographic token. The random cryptographic token is not stored on local memory after the mapping to the physical representation.

First interface 204 may be designed to obtain a selection of a desired multi-party communication (MPC) protocols, for encryption and/or signing. For example, the user presses an icon on a touchscreen requesting MPC, and may enter the number of parties.

Second interface 206 is designed and/or sized and/or shaped for receiving a blank physical key 214. For example, second interface 206 is implemented as a clamp and/or holder designed to hold one side of blank physical key 214 for enabling cutting of the other side of blank physical key 214.

Blank physical key 214 may be designed for cutting for fitting into a standard lock cylinder, for example, of a standard door and/or a standard portable lock. The ability to fit into the standard lock cylinder helps to “hide” the encoded physical key 216 in plain sight, such as on a keychain of car keys, house keys, gate keys, and the like. In some embodiments standard blank physical keys used to cut keys and/or copies of keys for standard doors, locks, cars, etc, may be used.

Circuitry 208 may be implemented as, for example, hardware designed to execute specific functions, and/or one or more processors executing code instructions stored on a memory and/or firmware. Circuitry 208 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Circuitry 208 may include a single processor, or multiple processors (homogenous or heterogeneous) arranged for parallel processing, as clusters and/or as one or more multi core processing devices.

Circuitry 208 may be in communication with first interface 204, and/or second interface 206, and/or cutting component 210, and/or a second component 218 (as described below).

Circuitry 208 is designed (e.g. in hardware, and/or for executing code instructions) for mapping the cryptographic token to a format of the geometrical representation for cutting and/or engraving on blank physical key 214 for generating encoded physical key 216.

Circuitry 208 is designed for operating cutting component 210 for cutting and/or engraving the geometrical representation on the blank physical key 214 according to the format, for generating encoded physical key 216.

Cutting component 210 may be implemented as, for example, a laser cutting a punch machine, based on a key cutting machine, saw and/or other device for cutting and/or shaping rigid materials such as metal, and the like.

The geometrical representation is a physical feature of the blank physical key 214, made by cutting and/or engraving the blank physical key 214 itself.

As used herein, the term cutting and/or engraving, for generating an encoded physical key(s), may include formation of holes, such as by drilling.

Optionally, the geometrical representation excludes printing and/or marking the surface of the blank physical key. The geometrical representation is made by physically changing the shape of the material from which the blank physical key is made from, such as by forming teeth and/or bores and/or holes.

The geometrical representation may include multiple parameters that correspond to characters of the cryptographic token, for example, mapped by a mapping function. A single character may be mapped to a unique value of a parameter, and/or a combination of characters may be mapped to a unique combination of parameters. Examples of the parameters of the geometrical representation include: number of teeth, angle of teeth, height of teeth, pattern of teeth, holes (e.g., depression) in a blade of the encoded physical key, depth of holes, diameter of holes, whether the hole is a depression in the blade that does not extend the entire thickness of the blade or whether the hole is an aperture through the thickness of the blade, and distribution pattern of holes.

As used herein, the terms depression and hole may sometimes be interchanged.

When the cryptographic token is a seed phrase defined by the cryptographic process, circuitry 208 may compute a private cryptographic key from the seed phrase. The private cryptographic key may be mapped by circuitry 208 to the geometrical representation. Alternatively, the seed phrase is directly mapped to the geometrical representation by circuitry 208.

When a PIN number is received, circuitry 208 may map the PIN number to another geometrical representation which may be part of the geometrical representation computed for the cryptographic token, or may be distinct from the geometrical representation computed for the cryptographic token. Circuitry 208 may operate cutting component 210 for cutting and/or engraving the additional geometrical representation on the blank physical key 214.

Circuitry 208 may be designed for mapping the cryptographic token 212 into multiple geometrical representations in response to a selection of MPC, optionally according to a number of selected parties. Circuitry 208 may be designed for operating cutting component 210 for cutting and/or engraving the selected number of geometrical representations (corresponding to the number of parties participating in MPC) on multiple blank physical keys 214.

Cutting component 210 may be designed for cutting and/or engraving the geometrical representation for fitting within a lock cylinder for enabling rotation of the lock cylinder when the encoded physical key is located within the lock cylinder. The lock cylinder may be part of the decoder described herein. Alternatively, the lock cylinder may be part of a standard door, car, gate, lock, etc . . . . Enabling the geometrical representation to fit within the standard lock cylinder aids in “hiding” encoded physical key 216 in plain sight. For example, a malicious entity getting hold of a set of keys that include real keys for doors, cars, locks, etc and the encoded physical key will be unable or have great difficulty determining which is the encoded physical key, since all keys will fit into standard locks.

Cutting component 210 may be designed for cutting and/or engraving the geometrical representation for displacement of pins of the lock cylinder of the decoder described herein. The geometrical representation may be cut and/or engraved to be read according to the displacement of the pins by the encoded physical key located within the lock cylinder of the decoder.

Optionally, circuitry 208 is designed for operating second component 218 for generating the lock cylinder 220 corresponding to the geometrical representation of the encoded physical key 216 created from the cryptographic token 212. Lock cylinder 220 may be generated for rotation and reading the corresponding geometrical representation of the encoded physical key 216 created from the cryptographic token 212. Lock cylinder 220 may be designed for non-rotation and non-reading another geometrical representation different than the geometrical representation of the encoded physical key. In this manner, lock cylinder 220 may be unique, in that only encoded physical key 216 created from the cryptographic token 212 is designed to fit for turning lock cylinder 220. Other keys, such as other encoded physical keys created from other cryptographic tokens are unable to turn the lock cylinder.

Alternatively, cutting component 210 may be designed for cutting and/or engraving the blank physical key for being read by a universal reader of the decoder, that decodes different geometrical representations of a different physically encoded keys. Different encoded physical keys created from different cryptographic tokens may all be designed to fit into the same universal reader, which is able to read each unique geometrical representation using the same hardware.

Referring now back to FIG. 3, an encoded physical key 302 is made from a blank physical key 304 including a cut and/or engraved geometrical representation 306 of a cryptographic token defined by a cryptographic process.

Geometrical representation 306 is a physical representation of a cryptographic token described herein, for example, as described with reference to FIG. 2. The cryptographic token may be, for example, a seed phrase, and/or private key.

Geometrical representation 306 is a physical feature of the blank physical key 304, made by cutting and/or engraving the blank physical key 304 itself, such as by the cutting element of the encoder described herein. Cutting and/or engraving includes formation of depressions and/or holes.

Geometrical representation 306 physically represents multiple parameters corresponding to the cryptographic token, for example, corresponding to and/or mapped from characters of the cryptographic token. Examples of the parameters of geometrical representation 306 include: number of teeth, angle of teeth, height of teeth, pattern of teeth (one tooth 308 marked for clarity), holes (e.g., depression) in a blade 320, depth of holes, diameter of holes, whether the hole is a depression in the blade that does not extend the entire thickness of the blade or whether the hole is an aperture through the thickness of the blade, distribution pattern of holes, (two holes 310 and 312) marked for clarity.

Geometrical representation 306 may include two regions that are cut and/or engraved. A first region 330 may represent the cryptographic token. A second region 332 may represent a PIN or other identifier, as described herein.

The blank physical key 304 and/or encoded physical key 302 may be designed for cutting for fitting into a lock cylinder of the decoder described herein. Alternatively or additionally, the blank physical key 304 and/or encoded physical key 302 is designed for filling into a standard lock cylinder, for example, of a door, a car door, a lock, and the like, such as for preventing or reducing likelihood of a malicious entity being able to differentiate encoded physical key 302 from a standard key, as described herein.

Encoded physical key 302 may be designed and/or cut for being read by a universal reader that decodes different geometrical representations of different encoded physical keys. The universal reader may be implemented as a lock cylinder with universal reading capabilities. The universal reader may be part of the decoder described herein. Alternatively, encoded physical key 302 may be designed and/or cut for fitting into a customized lock cylinder that is created to operate (e.g. turn) for signing and/or encrypting data in response to geometrical representation 306 of the specific encoded physical key 302, and be inoperable (e.g., not turn) and not signed and/or encrypt data in response to a different encoded physical key with different geometrical representation. The customized lock cylinder may be created as described herein.

Referring now back to FIG. 6, an encoded physical key 602 is made from a blank physical key 604 including a cut and/or engraved geometrical representation 606 of a cryptographic token defined by a cryptographic process. Blank physical key 604 may define a matrix. Each row 608 of matrix may define a respective number, for example, from 1-12, which may be engraved to aid understanding by a human. Each column 610 may represent one bit in the number represented by the row, where the right most bit represents two to the power of zero, and the left most bit represents two to the power of 11 (2048). Different numbers and/or other encodings by bits may be represented by engraving corresponding elements of the matrix.

Referring now back to FIG. 4, decoder 402 includes a first interface 404, a second interface 406, a reading component 408, and circuitry 410.

First interface 404 is designed for receiving digital data on which the cryptographic token is applied, for example, for encryption and/or signing. For example, for signing transactions of cryptocurrencies for storage by a blockchain.

First interface 404 may be implemented as a data interface, optionally a network interface for communication with one or more computing environments 422 (e.g., external computing devices, computing clouds, servers, and the like) over a network 420 for receiving the data for encryption and/or signing, and sending the encrypted data and/or signed data. Alternatively or additionally, first interface 404 may be implemented as a user interface for entering of the data to be encrypted and/or signed, for example, a touchscreen, a keyboard, a mouse and screen, and a voice based controller.

The network interface implementation of first interface 404 for connecting to network 420 may be implemented as, for example, one or more of, a network interface card, a wireless interface to connect to a wireless network, a physical interface for connecting to a cable for network connectivity, a virtual interface implemented in software, network communication software providing higher layers of network connectivity, and/or other implementations.

Network 420 may be implemented as, for example, the internet, a local area network, a virtual network, a wireless network, a cellular network, a local bus, a point to point link (e.g., wired), and/or combinations of the aforementioned.

Alternatively, the data interface, is a different interface than first interface 404, i.e., in addition to first interface 404.

Second interface 406 is signed and/or shaped and/or designed for receiving an encoded physical key 412 with a cut and/or engraved geometrical representation, which may represent a private cryptographic key. Encoded physical 412 may be created by the encoder described herein, for example, with reference to FIG. 2, and/or may correspond to encoded physical key 302 described with reference to FIG. 3.

The geometrical representation of the encoded physical key 412 is a physical representation of a cryptographic token described herein, for example, as described with reference to FIG. 2. The cryptographic token may be, for example, a seed phrase, and/or private key. In the case of the geometrical representation representing the seed phrase, circuitry 410 may convert the seed phrase to a private cryptographic key for encryption and/or signing of data.

There may be a single second interface 406 for insertion of a single encoded physical key. In the case of a MPC protocol, each encoded physical key of multiple encoded physical keys involved in the MPC may be inserted sequentially, according to no particular order or according to a defined order. Alternatively, there may be multiple second interfaces 406 for simultaneous insertion of multiple encoded physical keys involved in MPC.

Second interface 406 may be implemented as a lock cylinder designed for insertion of the encoded physical key therein.

Optionally, the lock cylinder is designed as a universal interface for operation (e.g. rotation) in response to insertion of any encoded physical key. Second interface 406 may read any geometrical representation on any one of different encoded physical keys each with a different respective geometrical representations. The universal interface design enables using the same lock cylinder with any created encoded physical key.

Alternatively, the lock cylinder is designed as a specific interface for operation (e.g. rotation) and/or for reading a unique geometrical representation on a specific encoded physical key with unique geometrical representation. The lock cylinder is designed for non-operation (e.g. non-rotation) and/or non-reading of the another geometrical representation different than the unique geometrical representation. The specific lock cylinder may be made by the encoder described herein in association with cutting and/or engraving the specific geometrical representation, as described herein.

Alternatively, the lock cylinder may be designed as a specific interface for operation (e.g., rotation) and/or reading of a defined set of geometrical representations on a set of encoded physical keys generated based on a MPC protocol. The lock cylinder may be designed for non-operation (e.g., non-rotation) and/or non-reading of other geometrical representations different than the defined set of geometrical representations of the MPC protocol. The specific lock cylinder may be made by the encoder described herein in association with cutting and/or engraving the multiple specific geometrical representations for MPC, as described herein.

Second interface 406 may include, have integrated therein, and/or be in communication with, reading component 408 designed for reading the geometrical representation from the encoded physical key for obtaining the cryptographic toke, optionally the private cryptographic key. Reading component 408 may be triggered in response to a rotation of the lock cylinder with encoded physical key inserted therein.

In embodiments in which second interface 406 is implemented as a lock cylinder, reading component 408 may be implemented as adjustable elements, optionally pins positioned within the lock cylinder set for displacement in response to the geometrical representation by the encoded physical key located within the lock cylinder. The geometrical representation may be read according to the displacement of the elements (e.g., pins).

Circuitry 410 may be implemented as, for example, hardware designed to execute specific functions, and/or one or more processors executing code instructions stored on a memory and/or firmware. Circuitry 410 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Circuitry 410 may include a single processor, or multiple processors (homogenous or heterogeneous) arranged for parallel processing, as clusters and/or as one or more multi core processing devices.

Circuitry 410 may be in communication with first interface 204, and/or cutting second interface 406 and/or reading component 408.

Circuitry 410 is designed for signing and/or encrypting the digital data (obtained via first interface 404) using the private cryptographic key (or other cryptographic token) obtained by reading encoded physical key 412.

Circuitry 410 computes the signature and/or encryption (and/or other operation using the cryptographic token) of the digital data without storing the private cryptographic key (or other cryptographic token) and/or without storing a digital representation of the private cryptographic key on a memory.

Circuitry 410 may be designed for disabling the data interface (e.g., first interface 404) during the signing and/or the encryption of the digital data. Disabling the data interface during the signing and/or encryption of the digital data secures the cryptographic token (e.g., private key) by preventing access to the cryptographic token (e.g., private key) used for the signing and/or encryption of the data, for example, by malicious entities attempting to obtain the cryptographic token via a remotely connected device.

Circuitry 410 may be designed for disabling the data interface (e.g., first interface 404) in response to reading component 408 detecting the presence of encoded physical key 412 in second interface 406 (e.g., lock cylinder).

Circuitry 410 may be designed for enabling and/or operating the data interface (e.g., first interface 404) in response to removal of encoded physical key 412 from the second interface 406, optionally from the lock cylinder, and/or in response to reader 408 determining that no encoded physical key 412 is present in second interface 406.

Circuitry 410 may be designed for sending the signed digital data and/or the encrypted digital data over the data interface (e.g., first interface 404) after the signing and/or encrypting is complete.

Circuitry 410 may be designed for non-simultaneous operation of the data interface (e.g., first interface 404) and second interface 406. Circuitry 410 may disable second interface 406 when the data interface (e.g., first interface 404) is operable for sending and/or receiving of data. Circuitry 410 may disable the data interface (e.g., first interface 404) when second interface 406 is reading the geometrical representation. The non-simultaneous operation secures the cryptographic token (e.g., private key) by preventing access to the cryptographic token (e.g., private key) read from the geometrical representation via the data interface, for example, by malicious entities attempting to obtain the cryptographic token via a remotely connected device.

Decoder 402 may include a third interface 426 designed for receiving a PIN entered by a user, for example, a touchscreen, keyboard, voice activated controller, and the like. Reader 408 may be designed for reading a PIN from the encoded physical key 412. Circuitry 410 may be designed for performing the signings and/or encrypting in response to a match of the PIN obtained from third interface 426 with the PIN obtained from encoded physical key 412. Circuitry 410 may be designed to prevent and/or not perform the signings and/or encrypting in response to a mismatch of the PIN obtained from third interface 426 with PIN obtained from the encoded physical key 412. The PIN may provide an added layer of security, and/or may be used to identify specific users.

Decoder 402 may include and/or be in communication with a user interface 450 for presentation of data to a user, for example, a screen and/or lights and/or message display. User interface 450 may present, for example, instructions to the user on what to do (e.g., place encoded physical key 412 in second interface 406, turn the key when in the lock cylinder, provide digital data for encrypting and/or signing) and/or present an indication of a current state of encoder 202 (e.g., waiting for key, computing signature and/or encrypted data, sending signed and/or encrypted data). User interface 450 may be combined and/or integrated with first interface 404 and/or third interface 426, for example, as a touch screen for a user to enter data and for presentation of instruction and/or the current state.

Decoder 402 may include a memory 424 configured for storing the digital data and/or the signature and/or encryption of the digital data. As described herein, memory 424 does not store the cryptographic token, such as the private key, obtained by reading the geometrical representation of encoded physical key 412.

Referring now back to FIG. 5, features described with reference to FIG. 5 are for operating one or more components described with reference to FIGS. 1-4.

At 502, a cryptographic token is entered into the first interface of the encoder.

At 504, a blank physical key is inserted into the second interface of the encoder.

At 506, the encoder cuts and/or engraves a geometrical representation of the cryptographic token (e.g., according to a mapping) on the blank physical key.

At 508, an encoded physical key, created by the cutting and/or engraving of the geometrical representation on the blank physical key, is removed from the encoder.

At 510, features described with reference to 504-508 may be iterated for generating a set of encoded physical keys as part of a MPC protocol for encryption and/or signing.

At 512, the encoded physical key, which may resemble a standard key such as for a door into a building, a car door, or a lock, may be stored. For example, the encoded physical key may be stored on a key chain along with other keys (e.g., for the door of the building, car, lock) without drawing attention to it. An observer may be unable or have difficulty in visually distinguishing the encoded physical key from the other keys.

At 514, digital data for encryption and/or signing is received via the first interface of the decoder.

At 516, the encoded physical key is inserted into the lock cylinder of the decoder.

At 518, the encoded physical key is rotated within the lock cylinder.

At 520, in response to the rotation, the geometrical representation is read from the encoded physical key for obtaining a private cryptographic key (or other cryptographic token).

At 522, features described with reference to 516-520 may be iterated for computing an aggregated private cryptographic key (or other cryptographic token) from a set of encoded physical keys as part of a MPC protocol for encryption and/or signing.

At 524, the digital data is signed and/or encrypted without storing the private cryptographic key and/or digital representation of the private cryptographic key(s).

At 526, the encrypted and/or signed data may be sent to a computing environment over a network via a data interface of the decoder.

It is expected that during the life of a patent maturing from this application many relevant cryptographic approaches will be developed and the scope of the term cryptographic is intended to include all such new technologies a priori.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A device for signing and/or encrypting digital data using an encoded physical key, comprising:
a first interface configured for receiving digital data;
a second interface configured for receiving an encoded physical key with a cut and/or engraved geometrical representation representing a private cryptographic key, the second interface implemented as a lock cylinder configured for insertion of the encoded physical key therein;
a reading component configured for reading the geometrical representation from the encoded physical key for obtaining the private cryptographic key, in response to a rotation of the lock cylinder with encoded physical key inserted therein;
circuitry configured for:
signing and/or encrypting the digital data using the private cryptographic key obtained by reading the encoded physical key,
wherein the circuitry computes the signature and/or encryption of the digital data without storing the private cryptographic key and/or without storing a digital representation of the private cryptographic key on a memory.

2. The device of claim 1, wherein the lock cylinder is configured as a universal interface for rotation and reading the geometrical representation on a plurality of different encoded physical keys with different geometrical representations.

3. The device of claim 1, wherein the lock cylinder is configured as a specific interface for rotation and reading a unique geometrical representation on a specific encoded physical key with unique geometrical representation, wherein the lock cylinder is configured for non-rotation and non-reading a geometrical representation different than the unique geometrical representation.

4. The device of claim 1, wherein the lock cylinder is configured as a specific interface for rotation and reading a defined set of a plurality of geometrical representations on a set of a plurality of encoded physical keys generated based on a multi-party computation (MPC) protocol for encryption and/or signing, wherein the lock cylinder is configured for non-rotation and non-reading a geometrical representation different than the defined set of the plurality of geometrical representations.

5. The device of claim 1, further comprising the memory configured for storing the digital data and the signature and/or encryption of the digital data.

6. The device of claim 1, further comprising a data interface configured for interfacing with at least one of a network and an external computing environment for sending and/or receiving digital data, and the circuitry is further configured for disabling the data interface during the signing and/or the encryption.

7. The device of claim 1, further comprising a data interface configured for interfacing with at least one of a network and an external computing environment, and the circuitry is further configured for sending the signed digital data and/or the encrypted digital data over the data interface after the signing and/or encrypting is complete.

8. The device of claim 1, further comprising a data interface configured for interfacing with at least one of a network and an external computing environment for sending the signed digital data and/or the encrypted digital data, and the circuitry is further configured for non-simultaneous operation of the data interface and the second interface, wherein the second interface is disabled when the data interface is operable for sending and/or receiving of data, and the data interface is disabled when the second interface is reading the geometrical representation.

9. The device of claim 1, further comprising a third interface for receiving a PIN entered by a user, wherein the reading component is further configured for reading a PIN from the encoded physical key, and the circuitry is further configured for performing the signings and/or encrypting in response to a match of the PIN obtained from the third interface with the PIN obtained from the encoded physical key, and not performing the signings and/or encrypting in response to a mismatch of the PIN obtained from the third interface with the PIN obtained from the encoded physical key.

10. The device of claim 1, further comprising:
a data interface configured for interfacing with at least one of a network and an extra computing environment and for sending of the signed digital and/or the encrypted digital data, and
wherein the circuitry is configured for operating the data interface in response to removal of the encoded physical key from the lock cylinder.

11. The device of claim 1, further comprising a data interface configured for interfacing with at least one of a network and an external computing environment for sending the signed digital data and/or the encrypted digital data, and the circuitry is further configured for disabling the data interface in response to the reading component detecting presence of the encoded physical key in the lock cylinder, and for enabling the data interface in response to the reading component detecting lack of presence of the encoded physical key in the lock cylinder.

12. The device of claim 1, wherein the cut and/or engraved geometrical representation represents a seed phrase defined by a cryptographic process, and further comprising circuitry for converting the seed phrase to the private cryptographic key.

13. The device of claim 1, wherein the reading component is implemented as a plurality of pins positioned within the lock cylinder, the plurality of pins set for displacement in response to the geometrical representation by the encoded physical key located within the lock cylinder, wherein the geometrical representation is read according to the displacement of the plurality of pins.

14. A device for physically generating an encoded physical key from a blank physical key, comprising:
a first interface configured for receiving a cryptographic token defined by a cryptographic process;
a second interface configured for receiving the blank physical key; and
further comprising circuitry configured for:
mapping the cryptographic token to a geometrical representation; and
operating a component for cutting and/or engraving the geometrical representation on the blank physical key for generating an encoded physical key comprising the geometrical representation of the cryptographic token on the blank physical key.

15. The device of claim 14, wherein the geometrical representation is cut and/or engraved for fitting within a lock cylinder for enabling rotation of the lock cylinder when the encoded physical key is located within the lock cylinder.

16. The device of claim 15, wherein the geometrical representation is cut and/or engraved for displacement of a plurality of pins of the lock cylinder, wherein the geometrical representation is read according to the displacement of the plurality of pins by the encoded physical key located within the lock cylinder.

17. The device of claim 15, further comprising circuitry configured for operating a second component for generating the lock cylinder corresponding to the geometrical representation of the encoded physical key, wherein the lock cylinder is generated for rotation and reading the corresponding geometrical representation of the encoded physical key and configured for non-rotation and non-reading a second geometrical representation different than the geometrical representation of the encoded physical key.

18. The device of claim 14, wherein the circuitry is further configured for operating the component for cutting and/or engraving a plurality of geometrical representations on a plurality of blank physical keys based on a multi-party computation (MPC) protocol for encryption and/or signing.

19. The device of claim 14, wherein the cryptographic token comprises a private cryptographic key defined by the cryptographic process.

20. The device of claim 14, wherein the cryptographic token comprises a seed phrase defined by the cryptographic process, and at least one of wherein the seed phrase is mapped to the geometrical representation, and wherein the circuitry is further configured for computing a private cryptographic key from the seed phrase, wherein the private cryptographic key is mapped to the geometrical representation.

21. The device of claim 14, wherein the blank physical key is designed for cutting for fitting into a lock cylinder.

22. The device of claim 14, wherein the component cuts and/or engraves the blank physical key for being read by a universal reader that decodes a plurality of different geometrical representations of a plurality of different keys.

23. The device of claim 14, wherein the first interface comprises a touchscreen and/or screen and keyboard for manual entry of the cryptographic token.

24. The device of claim 14, wherein the device excludes a data interface for connection to a network and/or external computing environment.

25. The device of claim 14, wherein the first interface is further configured for receiving a PIN number, the circuitry is further configured for mapping the PIN number to a second geometrical representation, and the component is further operated for cutting and/or engraving the second geometrical representation on the blank physical key.

26. The device of claim 14, wherein the geometrical representation includes a plurality of parameters corresponding to a plurality of characters of the cryptographic token, the plurality of parameters include at least one of: number of teeth, angle of teeth, height of teeth, pattern of teeth, holes in a blade, shape of holes, depth of holes, diameter of holes, distribution pattern of holes.

27. The device of claim 14, further comprising a random generator configured for generating random cryptographic tokens, wherein the first interface accesses the random generator for obtaining a random cryptographic token as the cryptographic token, wherein the random cryptographic token is not stored on local memory during and/or after the mapping to the geometrical representation.

28. An encoded physical key comprising:
a blank physical key including a cut and/or engraved geometrical representation of a cryptographic token defined by a cryptographic process.

29. The key of claim 28, wherein the blank physical key is designed for cutting for fitting into a lock cylinder.

30. The key of claim 28, wherein the encoded physical key is designed for being read by a universal reader that decodes a plurality of different geometrical representations of a plurality of different encoded physical keys.

31. The key of claim 28, wherein the geometrical representation includes a plurality of parameters corresponding to a plurality of characters of the cryptographic token, the plurality of parameters include at least one of: number of teeth, angle of teeth, height of teeth, pattern of teeth, holes in a blade, depth of holes, diameter of holes, distribution pattern of holes.

32. The key of claim 28, further including a cut and/or engraved second geometrical representation of a PIN.
